(19) United States
(12) Patent Application Publication
(10) Pub. No.: US 2009/0171650 A1
(43) Pub. Date: Jul. 2, 2009

(54) Non-Volatile memories in interactive entertainment systems

(75) Inventor: Robert Norman, Pendleton, OR (US)

Correspondence Address: UNITY SEMICONDUCTOR CORPORATION, 255 SANTA ANA COURT, SUNNYVALE, CA, 94085-4511, US

(73) Assignee: UNITY SEMICONDUCTOR CORPORATION, SUNNYVALE, CA (US)

(21) Appl. No.: 12/005,687

(22) Filed: Dec. 27, 2007

(51) Int. Cl. G06F 9/455; G06F 12/16

(52) U.S. Cl. 703/23; 711/161

(57) ABSTRACT

In accordance with an aspect of the present invention, an interactive entertainment system includes a processor configured to operate interactive entertainment programs, a non-volatile memory connected with the processor including a first portion for random access memory (RAM) emulation, an input/output (I/O) interface connected with the processor and the non-volatile memory to connect a user controller with the processor and the non-volatile memory, and a display interface connected to the processor and the non-volatile memory to output a display signal. The non-volatile memory may include additional portions for emulating read only memory (ROM) and Flash memory. The RAM may be emulated without a refresh operation and Flash memory may be emulated without an erase operation or an operating system. The non-volatile memory may include a plurality of two-terminal memory elements and may be vertically configured. The two-terminal memory elements may be resistivity-sensitive and store data in the absence of power.

### CROSS-REFERENCES TO RELATED APPLICATIONS

This application is related to U.S. patent application Ser. No. 11/095,026, filed Mar. 30, 2005, and titled “Memory Using Mixed Valence Conductive Oxides.”

### FIELD OF THE INVENTION

The present invention relates to interactive entertainment systems and specifically to memory usage in interactive entertainment systems.

### BACKGROUND

Interactive entertainment systems, such as video game consoles, allow users to use interactive software such as video games. Currently available video game consoles include the Xbox® by Microsoft® Corporation, and the various iterations of the Playstation® (e.g., Playstation® 2 (PS2), Playstation® 3, and Playstation® Portable (PSP)) by Sony® Computer Entertainment of America. An interactive entertainment system is a specialized computer system that typically outputs video to a television, and is operated using a simplified controller such as a joystick or game pad. An interactive entertainment system also typically has a simplified interface, and is often designed to be used by children or others who may not have the requisite skill to operate a more complex computer system such as a personal computer (PC). Another type of interactive entertainment system is a handheld video entertainment device, such as the Game Boy by Nintendo of America of Redmond, Wash., which incorporates many of the features of a video game console into a small, handheld package which also includes an integrated controller and display screen.

Interactive entertainment systems include several different memories which each have their own characteristic functions. A random access memory (RAM) is used by the processor and other components of an interactive entertainment system as transient data storage during operation. A RAM comprises some type of high-speed memory, such as dynamic RAM (DRAM), static RAM (SRAM), synchronous DRAM (SDRAM), etc. DRAM, SRAM, and SDRAM are volatile memories. A volatile memory loses its contents when power is removed. For example, when a computer system is powered down, the contents of the RAM are erased. As a result, an interactive entertainment system requires a typically lengthy boot process to load the operating system and initialize the various system devices. Further, if the interactive entertainment system unexpectedly loses power, any unsaved progress that a user may have made will be lost.

DRAM is the memory technology most commonly used for RAMs in interactive entertainment devices. DRAM requires frequent refresh cycles that reduce performance compared to SRAM. However, a DRAM cell is much smaller than an SRAM cell, allowing for higher cell densities at much lower cost, thereby making DRAM the preferred RAM technology for system memory.

Other memories that are used by interactive entertainment systems include read only memories (ROM), Programmable Read Only Memories (PROM), and Flash memories. A read only memory is a non-volatile, non-programmable memory or programmable once. A ROM or PROM typically stores at least a portion of the firmware, which comprises instructions for booting the interactive entertainment system. PROMs are write-once memories; they cannot be modified after the initial writing. ROMs are mask programmable in the factory and not alterable once made. A flash-memory can be written many times. Flash memories, like PROMs and ROMs, are non-volatile, and retain their contents when power is removed from them. Flash memories are types of electronically erasable programmable read-only memories (EEPROMs) that can only be written to after they have been erased. As a result, Flash memories are much slower than RAMs, and are typically used for storing data which is to be loaded into system memory or RAM. Flash memories also require an operating system (OS) for read/write capabilities.

Each of these memories has unique capabilities and requirements. Each has a unique architecture and therefore has unique semiconductor process steps, so each type of memory is usually enclosed in an individual package. Having several different memories therefore requires additional size and power consumption of the interactive entertainment device. Additionally, each of the above described memories has characteristics that have drawbacks. For example, the volatile nature of the RAM requires a lengthy boot process and lost data when a power interruption occurs, and Flash memory is slow enough that a user notices reads and writes during usage.

There are continuing efforts to improve memory used in interactive entertainment systems.

### BRIEF DESCRIPTION OF THE DRAWINGS

The present invention will be readily understood by the following detailed description in conjunction with the accompanying drawings, and like reference numerals designate like structural elements. Although the Drawings depict various examples of the invention, the invention is not limited by the depicted examples. Furthermore, the depictions are not necessarily to scale.

FIG. 1A is a system diagram of an interactive entertainment system according to one embodiment of the invention;

FIG. 1B illustrates a program cartridge;

FIG. 2A illustrates usage of a non-volatile memory;

FIG. 2B illustrates a vertical plane configuration of a non-volatile memory;

FIG. 2C illustrates a multi-port non-volatile memory according to one embodiment of the invention;

FIG. 3 is a flow diagram describing a process for updating an interactive entertainment system according to one embodiment of the invention; and

FIG. 4 is a flow diagram describing a process for storing transient program data according to one embodiment of the invention.

### DETAILED DESCRIPTION

Embodiments of the invention may be implemented in numerous ways, including as a system, a process, an apparatus, or as computer program instructions included on a computer readable medium such as a computer readable storage medium or a computer network wherein program instructions are sent over optical or electronic communication links.

A detailed description of one or more examples is provided below along with accompanying figures. The detailed description is provided in connection with such examples, but is not limited to any particular embodiment. The scope is limited only by the claims and numerous alternatives, modifications, and equivalents are encompassed. Numerous specific details are set forth in the following description in order to provide a thorough understanding. These details are provided for the purpose of example and the described embodiments may be implemented according to the claims without some or all of these specific details. For the purpose of clarity, technical material that is known in the technical fields related to the embodiments has not been described in detail to avoid unnecessarily obscuring the description.

According to one embodiment of the invention, an interactive entertainment device using a non-volatile memory is disclosed. The non-volatile memory may emulate the functions of several different types of memories. For example, the nonvolatile memory may include random access memory (RAM) emulation, read only memory (ROM) emulation, Programmable Read Only Memory (PROM) emulation, and Flash memory emulation. The interactive entertainment system may also include an input/output (I/O) interface that allows a user controller to control the interactive entertainment device and a display interface that outputs a display signal. For example, the user controller may be a joystick or other control pad, and the display signal may be outputted to a television or other display.

### Memory Technology

Non-volatile memory technologies may be used with memory systems to develop high density, low cost, and fast access memories. Access may refer to accessing and performing data operations (e.g., read, write, erase) on a memory or memory array, such as those developed by Unity Semiconductor, Inc. of Sunnyvale, Calif., which provide vertically-configured cell arrays (e.g., vertically-stacked, cross-point, two or three-terminal, non-volatile memory arrays) with reduced die sizes and manufacturing costs and system-level functionality. Examples of memory arrays may include vertically-stacked, two or three-terminal, cross-point memory arrays, such as those described in U.S. patent application Ser. No. 11/095,026, filed Mar. 30, 2005, and titled “Memory Using Mixed Valence Conductive Oxides,” hereby incorporated by reference in its entirety and for all purposes. The application describes a two-terminal memory element that changes conductivity when exposed to an appropriate voltage drop across the two terminals. A plurality of the two-terminal memory elements can be arranged in a cross-point array configuration. Multiple layers of the cross-point arrays may be vertically stacked upon one another to form the aforementioned vertically stacked array configuration. The memory element includes an electrolytic tunnel barrier and a mixed valence conductive oxide. The voltage drop across the electrolytic tunnel barrier causes an electrical field within the mixed valence conductive oxide that is strong enough to move oxygen ions out of the mixed valence conductive oxides and into the electrolytic tunnel barrier. Oxygen depletion causes the mixed valence conductive oxide to change its valence, which causes a change in conductivity. Both the electrolytic tunnel barrier and the mixed valence conductive oxide do not need to operate in a silicon substrate, and, therefore, can be fabricated above circuitry being used for other purposes (e.g., such as selection circuitry). The circuitry can be in a logic plane fabricated on a substrate (e.g., a silicon Si wafer) and the memory array can be positioned on top of the substrate. The memory element stores data as a plurality of conductivity profiles that can be non-destructively determined by applying a read voltage across the terminals of the memory element. The memory element retains stored data in the absence of power. The two-terminal memory elements can be arranged in a cross point array such that one terminal is electrically coupled with an x-direction line and the other terminal is electrically coupled with a y-direction line.

Both the electrolytic tunnel barrier and the mixed valence conductive oxide do not need to operate in a silicon substrate and, therefore, can be fabricated above circuitry being used for other purposes. The two-terminal memory elements can be arranged in a cross point array such that one terminal is electrically coupled with an x-direction line and the other terminal is electrically coupled with a y-direction line. A stacked cross point array consists of multiple cross point arrays vertically stacked upon one another, sometimes sharing x-direction and y-direction lines between layers, and sometimes having isolated lines. When a first write voltage V_{W1} is applied across the memory element, (typically by applying ½ V_{W1} to the x-direction line and ½ V_{W1} to the y-direction line) it switches to a low resistive state. When a second write voltage V_{W2} is applied across the memory element, (typically by applying ½ V_{W2} to the x-direction line and ½ −V_{W2} to the y-direction line) it switches to a high resistive state. Typically, memory elements using electrolytic tunnel barriers and mixed valence conductive oxides require V_{W1} to be opposite in polarity from V_{W2}.

Fast accesses for data operations may be achieved by using page buffers to allow multiple data operations to be performed substantially simultaneously (i.e., buffering data from a read and a write access) to the above described cross-point array. Further, various embodiments of data packet formats and data communication protocols may be used to indicate how data from different data operations (e.g., read, write, erase) may be aligned to allow fast accesses to a memory array.

### The Interactive Entertainment System

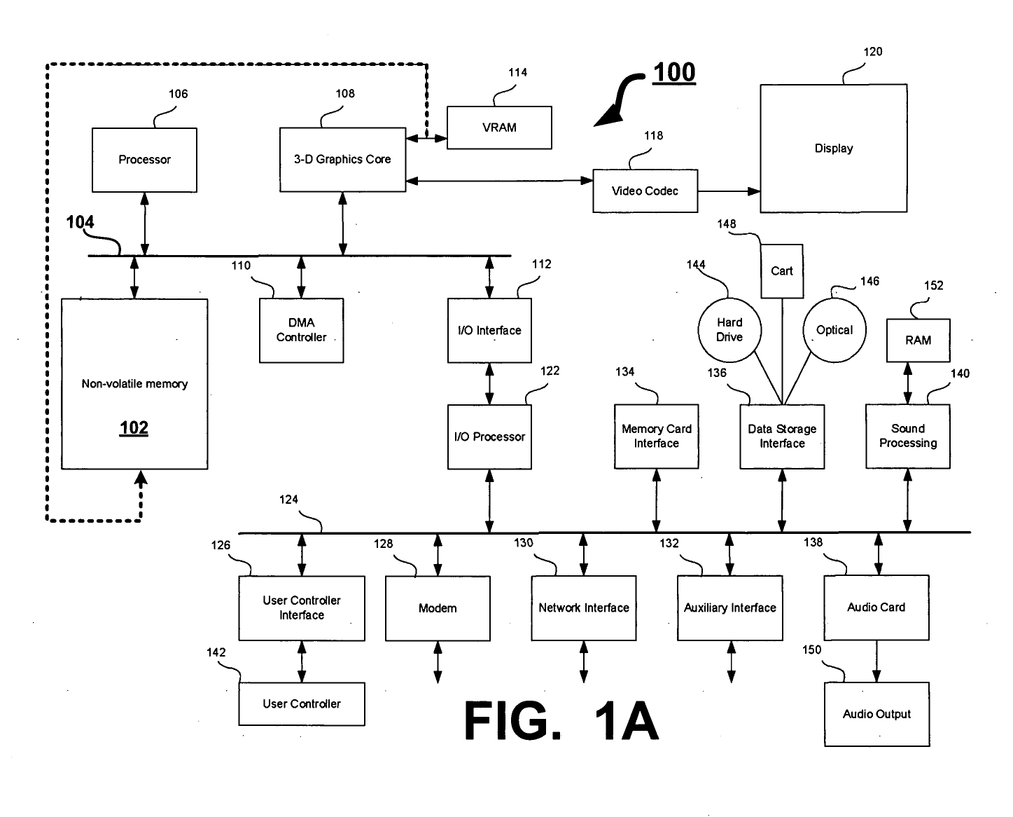

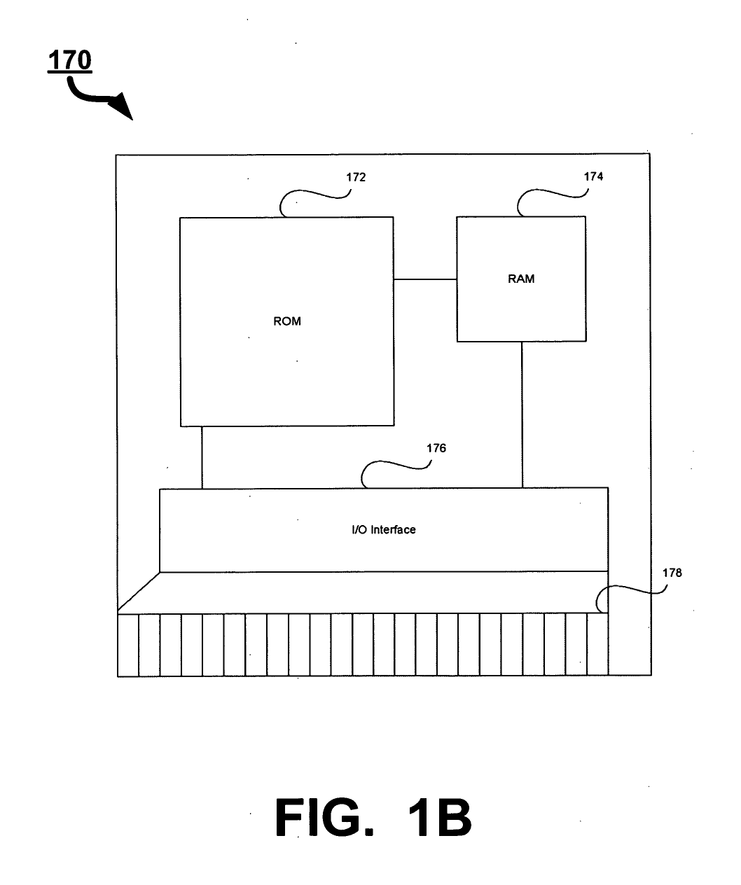

FIG. 1A is a system diagram depicting an interactive entertainment system 100 according to one embodiment of the invention. The interactive entertainment system 100 may be, for example, a video game console for playing interactive video games, which receives input through a user controller such as a joystick or game pad, and outputs video to a television or other display.

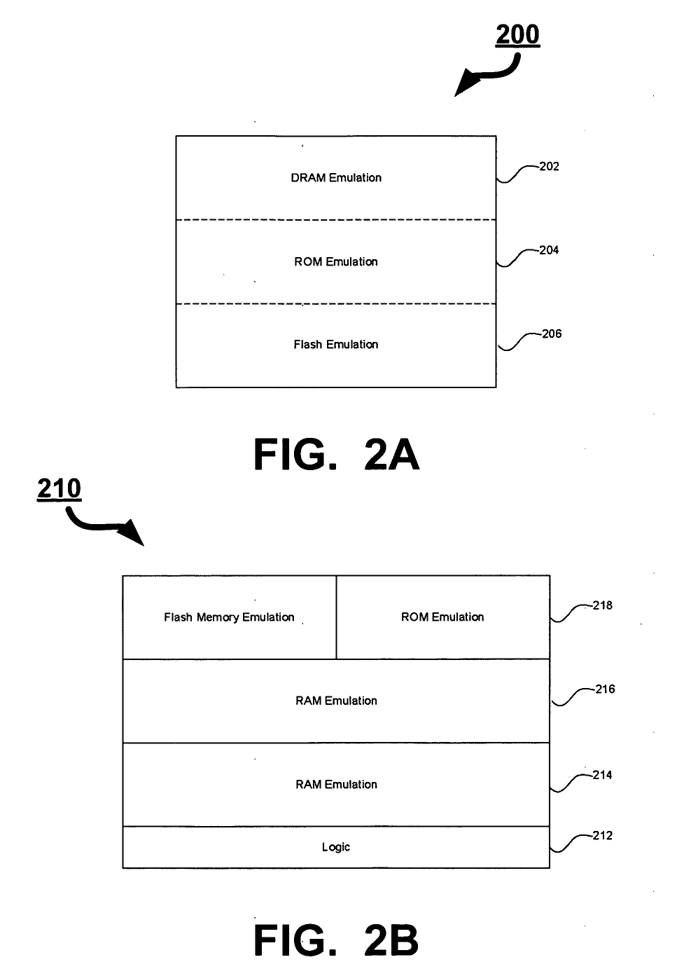

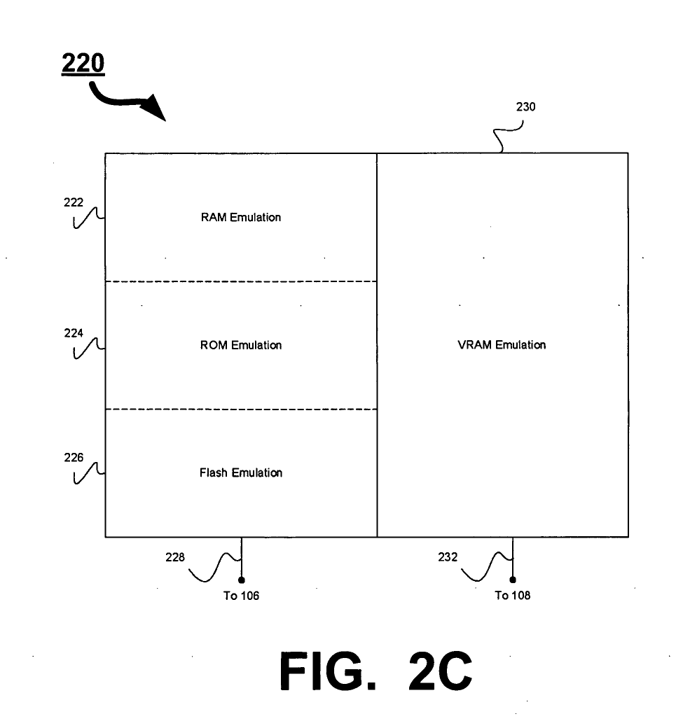

The interactive entertainment system 100 includes a unified non-volatile memory 102, which subsumes the functions of other memories of typical interactive entertainment systems. For example, the non-volatile memory 102 may emulate a random access memory (RAM), a read only memory (ROM), a Programmable Read Only Memory (PROM), and a Flash memory. The non-volatile memory 102 may be constructed using the non-volatile memory technologies described above. These technologies exhibit sufficient performance to replace traditional RAMs such as dynamic RAMs (DRAMs), static RAMs (SRAM), and are non-volatile without any form of battery backup (i.e., stored data is retained in the absence of power). The composition and function of various embodiments of the non-volatile memory 102 are discussed below regarding FIG. 2A through 2C. According to one embodiment, the non-volatile memory 102 includes two-terminal memory elements that may be vertically configured. The memory elements are resistivity-sensitive, and can be re-written without an erase operation and do not require a refresh operation.

The interactive entertainment system 100 includes several components connected through a bus 104. The bus 104 may represent one or more physical buses used to connect components in a computer system such as the interactive entertainment system 100. Attached to the bus 104 are a processor 106, the non-volatile memory 102, a three-dimensional (3-D) graphics core 108, a direct memory access (DMA) controller 110, and an input/output interface 112.

The processor 106 is configured to operate interactive entertainment programs such as video games, and may be one of any of several available microprocessors such as those manufactured by Intel® or Advanced Micro Devices®, for example. The processor 106 may be, for example, a 32-, 64-, or 128-bit processor, use a reduced instruction set computer (RISC) or complex instruction set computer (CISC) architecture, and/or perform vector processing.

The 3-D graphics core 108 includes a processor dedicated to creating graphics for the interactive entertainment system 100. The 3-D graphics core 108 may include a graphics processor such as those manufactured by NVIDIA® or ATI®, for example. The 3-D graphics core 108 may include some sort of polygon processing and/or pixel processing, and includes a dedicated video RAM (VRAM) 114. The VRAM 114 may comprise some type of dynamic random access memory (DRAM), static random access memory (SRAM), enhanced DRAM (EDRAM) or other memory technology. In one embodiment, the VRAM 114 may comprise the same type of memory used for the non-volatile memory 102 and as described above and in the referenced documents. In a further embodiment, the functions of the VRAM 114 may be subsumed by the non-volatile memory 102 as is signified by the connector 116, and as will be explained below regarding FIG. 2C. In this further embodiment, the separate VRAM 114 is not needed, and therefore may be excluded from the interactive entertainment system 100.

The 3-D graphics core 108 is also attached to a display interface such as a video encoder/decoder (codec) 118. The codec 118 prepares video data outputted by the 3-D graphics core 108 for display on a display 120. For example, the display 120 may be a television, LCD, DLP, or Plasma Display, using one of the National Television Standards Committee (NTSC) or Phase Alteration Line (PAL) formats, and the codec 118 outputs the video having proper resolution and frequency for the specific format of the display 120. In one embodiment, the interactive entertainment device 100 is a handheld video entertainment device, and the display 120 may be integrated into the interactive entertainment device.

The DMA controller 110 controls the movement of data between the non-volatile memory 102 and the 3-D graphics core 108 and I/O interface 112. The DMA controller 110 may also manage memory access for other devices that are attached to the bus 104, as is understood by those in the art.

The I/O interface 112 provides an interface between the I/O components of the interactive entertainment system 100 and the components connected to the bus 104. Attached to the I/O interface 112 is an I/O processor 122, which helps move data from the I/O components to the components attached to the bus 104. An I/O bus 124, which may comprise one or more physical buses, connects the various I/O components of the interactive entertainment system 100 to the I/O processor 122, the I/O interface 112, and the processing and memory components along the bus 104.

Units attached to the I/O bus 124 may include but are not limited to a user controller interface 126, a modem 128, a network interface 130, an auxiliary interface 132, a memory card interface 134, a data storage interface 136, an audio card 138, and a sound processing unit 140. Although specific I/O components are shown in FIG. 1A, it is understood that not all of the shown components are required, and that other components may be added according to various embodiments of the invention.

The user controller interface 126 connects to a user controller 142, such as a joystick or control pad that allows a user to play a video game or use another interactive program with the interactive entertainment system 100. The user controller interface 126 may use-a wired interface such as a serial interface, or may use a wireless interface, such as an infrared or Bluetooth interface to connect with the user controller 142. In one embodiment, the interactive entertainment device 100 is a handheld video entertainment device, and the user controller 142 may be integrated into the interactive entertainment device 100.

The modem 128 and the network interface 130 allow the interactive entertainment system 100 to network with other computer systems. Using these interfaces, a user may play networked games, for example. The network interface 130 may be, for example, an Ethernet or Fibre Channel interface. The auxiliary interface 132, may be, for example, a universal serial bus (USB) or an Institute of Electrical and Electronics Engineers (IEEE) standard 1394 (also known as Firewire) interface. The auxiliary interface 132 allows a user to attach auxiliary devices such as a printer or external storage device to the interactive entertainment system 100. The memory card interface 134 allows a user to transfer data to and from the interactive entertainment system 100 using memory cards. The memory card interface 134 may be, for example, a PC Card interface, a CompactFlash interface, a Secure Digital interface, etc. According to one embodiment of the invention, some of the functions of the memory cards that interface with the memory card interface 134 are subsumed by the non-volatile memory 102 using Flash memory emulation, as will be described below.

The data storage interface 136 communicates with and manages mass storage devices such as a magnetic hard drive 144 and an optical drive 146. The hard drive 144 may store program data and other stored data. According to one embodiment of the invention, some of the functions of the hard drive 144 are subsumed by the non-volatile memory 102. The optical drive 146 may be, for example, a compact disc read only memory (CD-ROM) drive or a digital versatile disc read only memory (DVD-ROM) drive. Media inserted into the optical drive 146 may contain the program data for games or other programs run on the interactive entertainment system 100.

According to another embodiment, the data storage interface 136 also communicates with a cartridge slot 148. The cartridge slot 148 may be included on any interactive entertainment system 100, but in one embodiment may be the primary source or program data storage when using a handheld video entertainment device. A program cartridge is shown in more detail in FIG. 1B.

The audio card 138 and the sound processing unit 140 produce sound for the interactive entertainment device 100. The sound processing unit 140 performs effects processing such as surround sound processing, and the audio card 138 converts the sound to a compliant signal (either digital or analog) which is outputted to the audio output 150. The audio output 150 may be, for example, an internal speaker, an analog audio signal output, or a digital audio signal output. The audio output 150 may connect to an external amplifier to output audio for the programs run on the interactive entertainment system 100. According to one embodiment, the sound processing unit 140 may access an associated RAM 152. Like the VRAM 114, the functions of the RAM 152 may be subsumed by the non-volatile memory 102, as will be explained below regarding FIG. 2C.

FIG. 1B illustrates a program cartridge 170. The program cartridge 170 includes a ROM 172, RAM 174, an I/O interface 176, and an edge connector 178. The program cartridge 170 may be, for example, a game cartridge used with a portable or handheld video entertainment device. The ROM 172 stores program instructions of the program to be executed when the program cartridge 170 is used. The RAM 174 stores transient data and, like the non-volatile memory 102, may be comprised of a non-volatile memory using a two-terminal memory element that is resistivity-sensitive, such as the memory described in the referenced document, above. The I/O interface 176 connects the ROM 172 and the RAM 174 to the edge connector 178 and manages incoming and outgoing data to and from the program cartridge 170. The edge connector 178 provides a physical connection between the interactive entertainment system 100 and the program cartridge 170 and allows for signals to be electrically communicated between the cartridge 170 and the entertainment system 100. The edge connector 178 may, according to one embodiment, include a series of conductive elements that allows multi-bit communication.

The program cartridge 170 may store state information in the RAM 174, which may assume the function of save game information. For example, when power is removed from the program cartridge 170, the RAM 174 retains any data written to it. The ROM 172 may include program instructions that specify that the RAM 174 stores data about current progress of the program. For example, if a user is playing a game stored in the ROM 172, and wishes to end play, the user may simply turn off the interactive entertainment system 100. When the user turns the interactive entertainment system 100 on again, the retained memory in the RAM 174 can resume the game program at the same point as when the user turned the interactive entertainment system 100 off. This will be explained in further detail below.

### Non-Volatile Memory Configuration

FIGS. 2A through 2C illustrate various views and uses of non-volatile memories that are examples of various embodiments of the non-volatile memory 102. It is understood that although these specific configurations are shown, various other configurations may be used within the purview of embodiments of the invention.

FIG. 2A illustrates usage of a non-volatile memory 200. As was described above, the non-volatile memory 200 uses a memory technology that is non-volatile, while still having sufficient performance to replace traditional RAMs. The non-volatile memory 200 may represent one embodiment of the non-volatile memory 102 of the interactive entertainment device 100. The non-volatile memory 200 uses a resistivity-sensitive memory element that may be a two-terminal memory element according to one embodiment of the invention. The memory elements are inherently non-volatile in that they retain their contents (e.g., data) until they are changed and retain stored data without continuous power such as a battery backup. Unlike DRAM, the non-volatile memory 200 does not require a refresh operation. Unlike Flash memory, the non-volatile memory 200 does not require an erase operation prior to a write operation and does not require an operating system (OS). The non-volatile memory 200 is therefore suitable for several different uses: the non-volatile memory 200 has sufficient performance to replace DRAM, while being non-volatile, allowing it to replace Flash memory and ROM. FIG. 2A depicts only one example of how the non-volatile memory 200 may be divided for various uses. For example, the non-volatile memory 200 may emulate the functions of several previously-used memories.

In this context, “emulation” refers to using a portion of the non-volatile memory 200 to perform, or emulate, the functions traditionally assigned to those memory types. For example, the non-volatile memory 200 includes a first portion 202 for RAM or DRAM emulation, a second portion 204 for ROM emulation, and a third portion 206 for Flash memory emulation. Each of the three portions 202-206 may be assigned a physical portion of the non-volatile memory 200. For example, if the non-volatile memory 200 totals 128 megabytes (MB), 96 MB may be allocated to RAM emulation, 2 MB may be allocated to ROM emulation, and 30 MB may be allocated to Flash emulation. Alternatively, the three portions 202-206 may be dynamically allocated, either when the interactive entertainment system 100 or a program boots, or during program operation, as needed. The allocation of the three portions 202-206 may be determined by the specific program being run or by the interactive entertainment system 100 based on the current needs of the program. Although not depicted in FIG. 2A, the non-volatile memory 200 may include a portion that emulates SRAM.

The non-volatile memory 200 may replace several memories. By using one unified memory rather than several different types of memories, several benefits are realized. First, less space is required on a mother board that carries the interactive entertainment system's 100. Also, by having fewer leads to the various integrated circuits (ICs) on the motherboard, less power is lost in transmission. Moreover, fewer leads can increase system reliability. Additionally, the technology of the non-volatile memory 200 requires less power and board space than other memory technologies. Other benefits relating to the non-volatility of RAM will be discussed below.

Using one existing video game console, during the gameplay portions of a typical video game, a user may periodically save their progress to a Flash memory card. The saved progress is saved in the format of save game data, which includes information about the user's position in the game as well as the user's status. When the user initiates the save, the video game console halts gameplay while the save game data is written to the Flash memory card. Flash memory requires an erase operation before a new write and requires an OS. Both factors make Flash memory very slow; reading or writing a saved game can take thirty seconds or more. The memory technology used for the non-volatile memory 200 requires no OS and no erase operation, as well as having much faster writes, which can greatly increase the performance and convenience of reading and recording save game data.

The first portion 202 may be used for RAM emulation. Since the emulated RAM is non-volatile, if power is interrupted, the RAM retains the current state of the program at the time of power loss. Therefore, a user can simply turn the interactive entertainment system 100 off when they are finished. When the user turns the interactive entertainment system 100 on again, the RAM retains its state, and gameplay will resume at the point at which the user turned the system off. With some programs or video games, this “state save” feature is sufficient to replace the save game function of previous video game consoles. In other embodiments, as will be discussed regarding Flash memory emulation, a user can continue to specify where to write save game data.

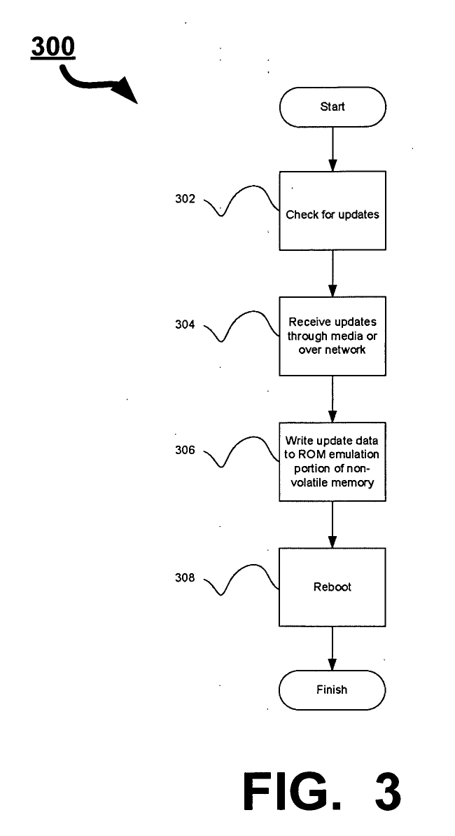

The second portion 204 may be used for ROM emulation. In a typical computer system, a ROM stores program instructions that are used to boot and initialize the system (the firmware). For example, a ROM may store instructions that instruct the system to boot the operating system stored on a mass storage device. In some systems, because a ROM is read-only, any firmware updates are stored in an auxiliary non-volatile memory such as a Flash memory that can be accessed by the ROM. In other systems, the firmware is stored in a rewritable memory such as a Flash memory. The functionality of storing the firmware is emulated by the ROM emulation in the second portion 204. A process for updating the ROM functionality is described regarding FIG. 3.

The third portion 206 may be used for Flash memory emulation. With some game programs, it may be necessary to save game data at certain points during gameplay rather than using continuous state saves (as described above). The interactive entertainment system 100 can seamlessly save game data at preconfigured points or when requested by a user. This may be necessary, for example, in video game where returning a player to the point immediately before the previous game ended would be counterproductive (for example, if the user's game character has just died). In such cases, the game may then end again immediately. The program can recognize the preconfigured points, and write save game data when those points are encountered either without user interaction or at the request of the user. Alternatively, the third portion 206 can store several memory states, allowing a user to choose where they would prefer to return to. The third portion 206 that includes Flash memory emulation may emulate the function of traditional memory cards which store save game data.

FIG. 2B illustrates a vertical plane configuration of a non-volatile memory 210. The non-volatile memory 210 is one example of a possible configuration for the non-volatile memory 102. According to one embodiment, the non-volatile memory 210 may have a vertical configuration, so that memory elements of the non-volatile memory 210 are arranged in three dimensions, or here in several vertical planes 212-218. The first plane, or base plane 212 of the non-volatile memory 210 houses the logic elements of the non-volatile memory 210, and possibly other circuitry not functionally related to the non-volatile memory 210. The logic elements allow access to and control the memory elements of the non-volatile memory 210. For example, the logic elements may include a memory controller and sensors (e.g., sense amplifiers) to measure the contents (e.g., stored data) of the memory elements.

The second plane,214 and the third plane 216 house the memory elements for the RAM emulation of the non-volatile memory 210. According to one embodiment, because RAM emulation requires faster memory access than ROM or Flash emulation, the RAM emulation memory elements are located physically closer to the logic elements in the base plane 212, and therefore take less time to access. As shown here, the RAM emulation may use two planes 214 and 216 because more memory may be needed for RAM emulation than for ROM or Flash memory emulation.

The fourth plane 218 includes memory elements for Flash memory emulation and for ROM emulation. It is understood that various other configurations of the non-volatile memory 210 may be realized as necessitated by the specific application. For example, the planes 212-218 may include VRAM emulation of the VRAM 114, a described above in reference to FIG. 1A. Although not depicted in FIG. 2B, one skilled in the art will understand that the non-volatile memory 210 will include an electrical interconnect structure that electrically couples the memory in planes 214-218 with the logic in base plane 212 (e.g., vias, contacts, plugs, damascene structures, etc.).

FIG. 2C illustrates a multi-port non-volatile memory 220 according to one embodiment of the invention. A multi-port memory such as the multi-port non-volatile memory 220 allows multiple devices of the interactive entertainment system 100 to access non-volatile memory independently. For example, the processor 106 and the 3-D graphics core 108 may both independently access the non-volatile memory 220 at different clock speeds, and access the same data at the same time. The multi-port non-volatile memory 220 is a single physical memory that can be accessed by many devices, further reducing the number of ICs required on the motherboard of the interactive entertainment device 100.

A first portion 222 of the multi-port non-volatile memory 220 may include RAM emulation similar to the emulation described above regarding FIG. 2A for access by the processor 106. A second portion 224 and a third portion 226 may include ROM and Flash emulation, respectively. The first, second, and third portions 222-226 may be accessed using a port 228 that is connected to the processor 106 through the bus 104.

A fourth portion 230 of the multi-port non-volatile memory 220 may include VRAM emulation which can be used by the 3-D graphics core 108 in place of the VRAM 114. The fourth portion 230 may be accessed using a port 232 that is connected to the 3-D graphics core 108 through the connection 116. According to other embodiments of the invention, the audio RAM 152 may also be incorporated into the multi-port non-volatile memory 220 by adding another port. According to further embodiments, the multi-port non-volatile memory 220 may incorporate vertically configured memory elements such as those shown in FIG. 2B.

### Firmware Updates

FIG. 3 is a flow diagram depicting a process for updating an interactive entertainment system according to one embodiment of the invention. The process of updating a computer system typically includes adding software updates to a Flash or other non-volatile programmable memory that stores the firmware or a portion of the firmware of the system. According to one embodiment of the invention, the interactive entertainment system 100, using the non-volatile memory 102, can overwrite the contents of the second portion 204 which performs ROM emulation, thereby updating the interactive entertainment system 100 with a new firmware version.

At a stage 302, the interactive entertainment system 100 checks for updates. This check can be performed in one of several ways. First, the interactive entertainment system 100 can, at a predetermined interval (e.g., every time the interactive entertainment system 100 boots), access a remote server to determine whether any updates are available. Alternatively, a user may prompt the interactive entertainment system 100 to search for available updates. Also, a remote server may notify the interactive entertainment system 100 that updates are available. Stage 302 may not be necessary where, for example, a user inserts a media device such as a CD-ROM or a memory card containing the update into the interactive entertainment system 100.

At a stage 304, the interactive entertainment system 100 receives updates through media or through a network. A user may insert a media device, such as an optical disc or a Flash memory card, which stores the updates. Alternatively, the updates can be transferred over a network through at least one interface including but not limited to the modem 128, the network interface 130, and the auxiliary interface 132, for example. The network may be a wireless network. The updates, once received, may be stored on the interactive entertainment device 100 in one or more of the non-volatile memory 102 or the hard drive 144, or another appropriate storage device. In another embodiment, the updates may be transferred directly to a memory such as the non-volatile memory 102.

At a stage 306, the updates are written to the second portion 204 of the non-volatile memory 200 (the ROM emulation portion). Either a sub-portion thereof or the entire second portion 204 may be overwritten by the updates depending on the requirements and instructions contained in the updates. By writing the updates to the second portion 204, when the interactive entertainment system 100 reboots, as in stage 308, the ROM is reloaded and the updates become effective. It is understood that although the second portion 204 is specified here, that the updates may be written to any portion of the non-volatile memory 200 as needed.

### Transient Data Storage

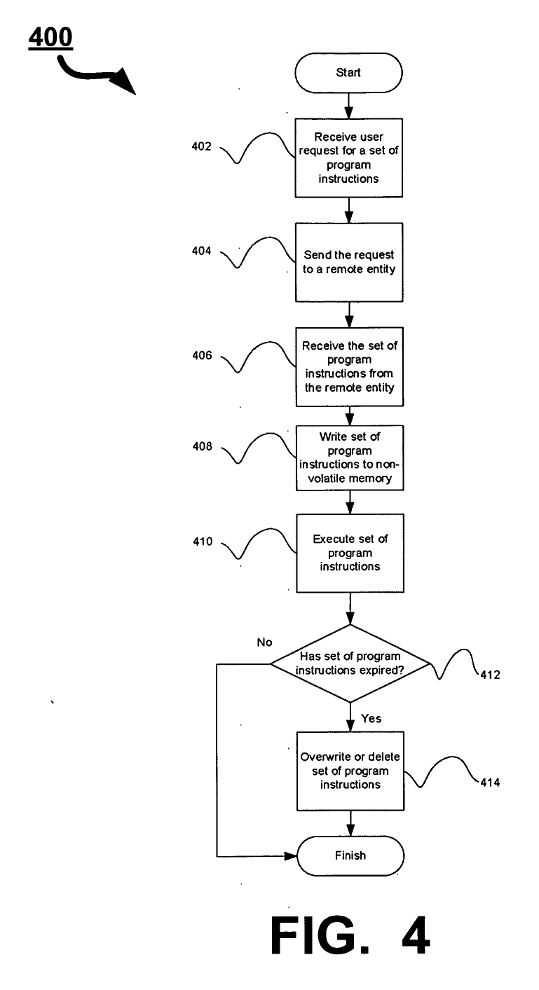

FIG. 4 is a flow diagram depicting a process for storing transient program data according to one embodiment of the invention. Using the interactive entertainment system 100, a user may download limited use programs, such as video games, that expire after a predetermined condition occurs. For example, a user may request a game download, which can be used until another game is downloaded. Several other predetermined conditions can be realized using the interactive entertainment system 100. Generally, these programs can be stored in the non-volatile memory 102, which is not only faster, but more secure than traditional storage media, such as a hard drive. The non-volatile memory 102 is more secure since the user may not be able to access the non-volatile memory as easily as a hard drive or other medium, making it more difficult to make copies of the downloaded program or to alter or tamper with the downloaded program.

At a stage 402, the interactive entertainment system 100 receives a user request for a set of program instructions, such as a game program. The user request may originate with a button press from the user controller 142, for example. At a stage 404, the request is sent to a remote entity, such as a server or other computer system on which the requested set of program instructions is stored. At a stage 406, the set of program instructions is received from the remote entity.

At a stage 408, the set of program instructions is written to a non-volatile memory, such as the non-volatile memory 102 described above. The set of program instructions may be written to a predetermined portion of the non-volatile memory that is specifically reserved for storing transient program data. At a stage 410, the interactive entertainment system operates the set of program instructions according to the instructions given by the user.

At a stage 412, the interactive entertainment system 100 determines whether the set of program instructions has expired. The set of program instructions expires upon the occurrence of a predetermined condition. The predetermined condition may be, for example, a user request to receive a new set of program instructions, the passage of a predetermined amount of time, a reboot of the interactive entertainment system 100, or any other condition. If the set of program instructions has expired, at a stage 414, the set of program instructions is overwritten or deleted. If the set of program instructions has expired because a user has requested a new set of program instructions, the new set of program instructions may be written over the existing set of program instructions (for example, in stage 408).

As an example of the operation of the above-discussed process, a user may request to play a video game that is offered on a “pay-per-play” basis. The interactive entertainment system 100, upon receiving the user's requests, forwards the request to a remote server on which the program data for the video game is available. The remote server transmits the program data to the interactive entertainment system 100. The interactive entertainment system 100 then stores the program data in the non-volatile memory 102. The interactive entertainment system 100 operates the program data, enabling the user to play the video game. In this example, the predetermined condition may indicate that the game expires after a single use by the user. When the user finishes playing the game, the program data is overwritten so that the game is no longer available.

With the above embodiments in mind, it should be understood that embodiments of the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Embodiments of the invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. An interactive entertainment system comprising:
a processor configured to operate interactive entertainment programs;
a non-volatile memory connected with the processor, the non-volatile memory including a first portion for random access memory (RAM) emulation;
an input/output (I/O) interface connected with the processor and the non-volatile memory, the I/O interface operative to connect a user controller with the processor and the non-volatile memory; and
a display interface connected with the processor and the non-volatile memory and operative to output a display signal.

2. The interactive entertainment system of claim 1, wherein the non-volatile memory does not require a refresh operation.

3. The interactive entertainment system of claim 1, wherein the non-volatile memory includes a second portion for read only memory (ROM) emulation.

4. The interactive entertainment system of claim 3, wherein data stored in the second portion includes a first set of instructions operative to update an operating system of the interactive entertainment system.

5. The interactive entertainment system of claim 1, wherein the non-volatile memory further includes a third portion for Flash memory emulation.

6. The interactive entertainment system of claim 5, wherein data stored in the third portion includes save-game data.

7. The interactive entertainment system of claim 5, wherein the Flash memory emulation is accomplished without an operating system.

8. The interactive entertainment system of claim 5, wherein the Flash memory emulation is accomplished without an erase operation.

9. The interactive entertainment system of claim 5, wherein data stored in the third portion includes a second set of instructions, the second set of instructions are stored in response to a user request, the second set of instructions are operative to provide an interactive game for the user, and wherein the second set of instructions are deleted from the third portion in response to a predetermined condition.

10. The interactive entertainment system of claim 9, wherein the predetermined condition is selected from the group consisting of a user request to receive a new set of instructions, a user request to receive a new set of program instructions, a user request to delete the second set of instructions, a passage of a predetermined amount of time, a download of a game, and a reboot of the interactive entertainment system.

11. The interactive entertainment system of claim 1, wherein the non-volatile memory comprises a two-terminal memory element.

12. The interactive entertainment system of claim 11, wherein the two-terminal memory element comprises a resistivity-sensitive memory element operative to store data as a plurality of conductivity profiles and operative to retain stored data in the absence of power.

13. The interactive entertainment system of claim 11, wherein the non-volatile memory comprises a vertically configured memory.

14. A handheld video entertainment device, comprising:
a processor configured to operate interactive entertainment programs;
a non-volatile memory connected with the processor, the non-volatile memory including a first portion for random access memory (RAM) emulation;
an input/output (I/O) interface connected with the processor and the non-volatile memory;
an integrated controller connected with the I/O interface and operative to control the handheld video entertainment device;
a display interface connected with the processor; and
an integrated display, the display interface operative to output video to the integrated display.

15. The handheld video entertainment device of claim 14 and further comprising:
a cartridge slot connected with the I/O interface, the cartridge slot configured to receive a cartridge, the cartridge including a second non-volatile memory for RAM emulation.

16. The handheld video entertainment device of claim 14, wherein the non-volatile memory includes a second portion for read-only memory (ROM) emulation and a third portion for Flash memory emulation.

17. The handheld video entertainment device of claim 16, wherein the non-volatile memory is vertically configured.

18. The handheld video entertainment device of claim 16, wherein the non-volatile memory includes a plurality of two-terminal memory elements that are resistivity-sensitive.

19. A method for storing transient program data, comprising:
receiving a request for a first set of program instructions;
sending the request to a remote entity;
receiving the first set of program instructions from the remote entity;
writing the first set of program instructions to a non-volatile memory;
executing the first set of program instructions; and
overwriting the first set of program instructions in response to a predetermined condition.

20. The method of claim 19, wherein overwriting the first set of program instructions in response to the predetermined condition comprises overwriting the first set of program instructions when a second set of program instructions is received.

21. The method of claim 19, wherein overwriting the first set of program instructions in response to the predetermined condition comprises overwriting the first set of program instructions after a predetermined period of time.

22. The method of claim 19, wherein writing the first set of program instructions to the non-volatile memory comprises writing the first set of program instructions to a two-terminal resistivity-sensitive non-volatile memory.

23. The method of claim 22, wherein writing the first set of program instructions to the two-terminal resistivity-sensitive non-volatile memory comprises writing the first set of program instructions to a two-terminal vertically-configured resistivity-sensitive non-volatile memory.
